(19) United States
(12) Patent Application Publication
(10) Pub. No.: US 2026/0300157 A1
(43) Pub. Date: Oct. 1, 2026

(54) DATA PLACEMENT WITH NAMESPACE GRANULARITY IN A MEMORY SUB-SYSTEM

(71) Applicant: MICRON TECHNOLOGY, INC., Boise, ID (US)

(72) Inventors: Chandra Guda, Fremont, CA (US); Pierre Labat, Campbell, CA (US)

(21) Appl. No.: 19/090,874

(22) Filed: Mar. 26, 2025

(51) Int. Cl. G06F 12/02

(52) U.S. Cl. CPC G06F 12/0246

(57) ABSTRACT

A system includes a memory device and a processing device coupled to the memory device, the processing device is to perform operations including: receiving, from a host system, a first write request, wherein the first write request includes a first data item and a first namespace; identifying, based on the first namespace, a region of the memory device, wherein the region is configured to store a lowest number of bits per cell supported by the memory device; and writing the first data item to the region of the memory device.

### TECHNICAL FIELD

Embodiments of the disclosure relate generally to memory sub-systems, and more specifically, relate to implementing data placement with namespace granularity in a memory sub-system.

### BACKGROUND

A memory sub-system can include one or more memory devices that store data.

The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system in accordance with some embodiments of the present disclosure.

FIG. 2 illustrates an example namespace association component that implements data placement with namespace granularity in a memory sub-system in accordance with some embodiments of the present disclosure.

FIGS. 3-4 are flow diagrams of example methods to implement data placement with namespace granularity in a memory sub-system in accordance with some embodiments of the present disclosure.

FIG. 5 is a block diagram of an example computer system in which embodiments of the present disclosure can operate.

### DETAILED DESCRIPTION

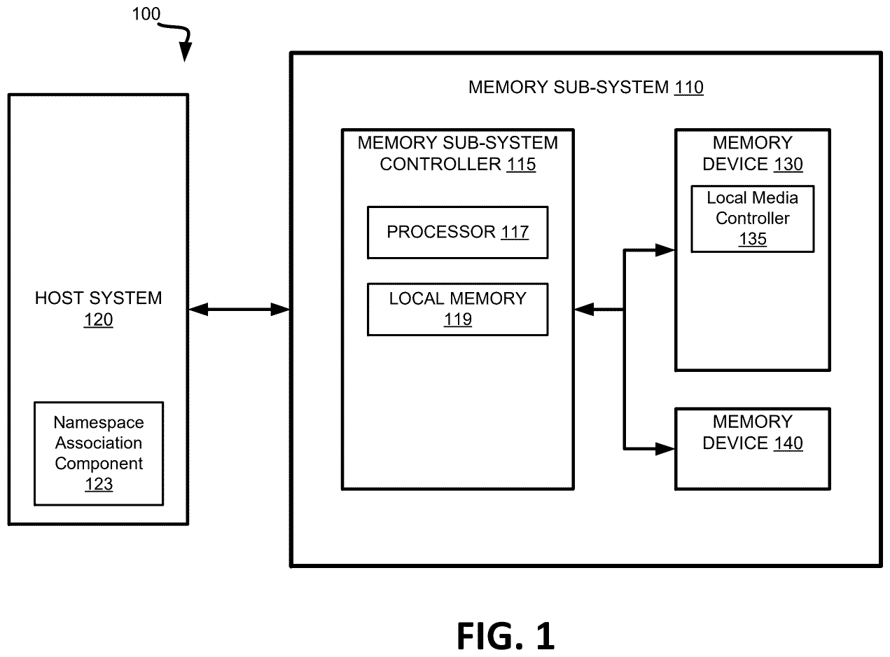

Aspects of the present disclosure are directed to implementing data placement with namespace granularity in a memory sub-system. A memory sub-system can be a storage device, a memory module, or a combination of a storage device and memory module. Examples of storage devices and memory modules are described below in conjunction with FIG. 1. An example of a memory sub-system is a storage device that is coupled to a central processing unit (CPU) via a peripheral interconnect (e.g., an input/output bus, a storage area network). Examples of storage devices include a solid-state drive (SSD), a flash drive, a universal serial bus (USB) flash drive, and a hard disk drive (HDD). Another example of a memory sub-system is a memory module that is coupled to the CPU via a memory bus. Examples of memory modules include a dual in-line memory module (DIMM), a small outline DIMM (SO-DIMM), a non-volatile dual in-line memory module (NVDIMM), etc. In some embodiments, the memory sub-system can be a hybrid memory/storage sub-system. In general, a host system can utilize a memory sub-system that includes one or more memory components. The host system can provide data to be stored at the memory sub-system and can request data to be retrieved from the memory sub-system.

A memory sub-system can include high density non-volatile memory devices where retention of data is desired when no power is supplied to the memory device. One example of a non-volatile memory device is a NAND memory device, such as 3D flash NAND memory, which offers storage in the form of compact, high density configurations. Other examples of non-volatile memory devices are described below in conjunction with FIG. 1. A non-volatile memory device is a package of one or more die. Each die can include one or more planes. For some types of non-volatile memory devices (e.g., NAND memory devices), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. The memory cells are formed onto a silicon wafer in an array of columns and rows. A wordline can refer to conductive lines connected to one or more rows of memory cells of a memory device and a bitline can refer to conductive lines connected to one or more columns of memory cells of a memory device. The intersection of a bitline and wordline constitutes the address of the memory cell. A block refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types.

Memory access commands, such as those sent by the host system, request the memory sub-system to perform memory access operations on the memory devices of the memory sub-system. Memory access commands can generally be classified into respective categories, such as read commands, write commands, erase commands, move commands, etc. A memory sub-system controller can receive the memory access commands from the host system connected externally to the memory sub-system, such as via a Non-Volatile Memory Express (NVMe) interface on a Peripheral Component Interconnect Express (PCIe) communication bus. The memory sub-system can execute the memory access commands to perform the memory access operations and return the results of executing the memory access commands to the host system via the host interface.

In some systems, data from various sources and/or of different types are written on the same physical block, while data from the same source of the same type may be scattered on different physical blocks. When data from the same source (e.g., data from a specific application) is deleted, the deletion of data will create fragmented free spaces on the physical block, and to use the fragmented free space, garbage collection (GC) is needed to move the valid data on the physical block to other blocks such that the physical block can be erased to reuse.

Flexible Data Placement (FDP) is a mechanism to write the data to separate physical spaces, reducing the garbage collection. FDP can be used via a set of the NVM commands as defined by the NVMeTM Specification. Specifically, FDP enables host-guided data placement to allow the data referenced by a specific placement identifier to be written to a corresponding reclaim unit (RU). A RU represents the smallest unit of physical, non-volatile storage that can be erased or reclaimed for reuse. For example, RUs may be blocks that can be programmed, read, erased, reused, or repurposed without disturbing each other. In some implementations, one or more RUs can form a reclaim group (RG), where an RG represents a logical grouping of the RUs such that all RUs in the logical group can be processed together for certain media management operations such as garbage collection. In one embodiment, the RGs can be physically isolated from each other to minimize the mutual interference of performance. A reclaim unit handle (RUH) can be used to identify a RU in a specific RG, and thus, a RUH in combination with an RG can identify a RU and can be used to direct the data of specific characteristics to the corresponding RU.

The host system can tag a write command with the specific placement identifier such as a placement handle identifier (PHI). Using PHI allows the host system to group data with similar characteristic. The memory sub-system controller can maintain a data structure that maps PHIs to corresponding RUHs and RGs. Upon receiving a write command tagged with a PHI, the memory sub-system controller can obtain the RUH and RG mapped to the PHI, and write the data to the RU (or RG) identified by the RUH and RG. The memory sub-system controller can thus perform the requested write operation on the identified RU. Thus, for each memory access command that includes PHI, the memory sub-system controller needs to process the PHI to determine the RUH and RG and determine the corresponding RU, which can adversely impact the system performance.

However, FDP might not provide an efficient way for data placement in certain situations, and certain processes performed by the memory sub-system controller can be simplified or skipped. For example, the host system may perform large language model training and produce, during the training, various data. Some data may be easily identified as a specific type, such as checkpoint data, which may refer to the application data that is saved at specific points of time. Other data can be used for interference and may be known to relate to parameters that cannot be easily identified. In some cases, instead of using separate memory devices to store different types of data, one memory device may be used to store the checkpoint data and the parameter-related data. Implementing FDP may provide a solution to store different types of data in a same memory device by storing one type of data in a separate region of the memory device, but implementing FDP in the full scope may cause high latency and high power consumption.

Aspects of the present disclosure address the above and other deficiencies by implementing a memory sub-system that allows efficient isolation of data in different types from each other. Specifically, a memory space used to store files of a specific data type (e.g., generated by an application) in a file system is isolated from another memory space in the same memory device used to store files other than the specific data type (e.g., generated by the same application) in another file system. For example, the specific data type may be the checkpoint data type, which refers to the application data that is saved at specific points of time and can be accompanied by metadata indicating its type as a checkpoint data type.

In some implementations, the host system may associate the data with a predefined file system, where the file system is designated to store data of a specific type and associated with a respective namespace of the memory device. A namespace refers to a logical address space unit of the memory device. Each namespace can be used independently to allow for more efficient management of data stored in the memory device. The host system may integrate the namespace information (such as namespace identifier that identifies the namespace) into the write command, and send the write command to a memory sub-system controller. The memory sub-system controller may process the namespace information included in the write command to identify the physical location for writing the data of the write command to the memory device. For example, the memory device may be a non-volatile memory express (NVMe) device, which is a non-volatile memory device that offers high throughput and low latency. The memory device includes a set of RUs (or other management units of a physical, non-volatile storage that can be programmed, read, erased, reused, or repurposed without disturbing each other) that can be referred to as an isolated region. Each isolated region is designated to store the data associated with a corresponding file system (and thus, a corresponding namespace). In some implementations, each namespace is created in a respective endurance group (EG). An EG refers to a logical group of RUs (or other management units) that can be managed independently. In one example, a first EG includes one isolated region that may be the storage configured as providing the fastest available read/write speed and low power consumption, such as single-level cell (SLC) memory, while a second EG includes the other region(s) of the memory device that may be the storage configured as providing slower read/write speed and high power consumption, such as triple-level cell (TLC) memory. As such, aspects of the present disclosure allow storing the data of a specific type (e.g., checkpoint data) in a corresponding isolated region of the memory device and the data other than the specific type (e.g., not checkpoint data) in the other region(s) of the memory device by having the memory sub-system controller use the association of file system and namespace to directly identify the physical location (e.g., isolated region) of the memory device.

In some implementations, the host system may configure the NVMe device via a set of NVMe commands (e.g., via NVMe command line interface (CLI)) as described above to have one isolated region associated with one namespace and the other region(s) associated with other namespaces. In some implementations, the host system may, via the NVMe commands, configure at least two EGs in the NVMe device. In some implementations, the host system may create multiple namespaces by allocating a set of RUs (“region”) to each namespace and map each namespace set by the host system to a respective EG. In some implementations, the memory sub-system controller may maintain a data structure (“EG mapping data structure”) to record the mapping between the namespace and the EG.

The host system may create multiple file systems, where each file system is associated with one namespace. For example, an application running on the host system may perform an AI model training and request to store data generated during the AI model training on the NVMe device and create multiple file systems to organize such data. The host system may create a data structure for mapping file systems to corresponding namespace. For example, the host system may create a data structure (“placement data structure”) that includes a set of records, and each record specifies a file system and a corresponding namespace.

The host system may create a file system (“specific-type file system,” e.g., first filesystem) on a first namespace, where the specific-type file system is designated to only store data of a specific type, such as checkpoint data. The host system may associate data (e.g., first data item) to the specific-type file system. The host system may translate the specific-type file system to a first namespace using the placement data structure.

The host system may create a file system (“general file system,” e.g., second filesystem) on a second namespace, where the general file system is designated to data other than the specific type, such as all types of data other than checkpoint data. The host system may associate data (e.g., second data item) to the general file system. The host system may translate the general file system to a second namespace using the placement data structure.

In some implementations, an application running on the host system may generate checkpoint data and other data, and the checkpoint data may be stored in a first file system that is associated with a first namespace and the other data may be stored in a second file system that is associated with a second namespace. For example, the application running on the host system may generate checkpoint data (e.g., first data item) to be stored in the specific-type file system. The host system may send a write request including the data (e.g., first data item) and the first namespace to the memory sub-system controller. The memory sub-system controller may translate the first namespace included in the write request into a EG (e.g., EG 1) using the EG mapping data structure, and the memory sub-system controller can use the EG to identify the isolated region of the NVMe device as the location for storing the data, and then store the data in the isolated region of the NVMe device.

As another example, the application running on the host system may generate other data (e.g., second data item) to be stored in the general file system. The host system may send a write request including the data (e.g., second data item) and the second namespace to the memory sub-system controller. The memory sub-system controller may translate the second namespace included in the write request into a EG (e.g., EG 2) using the EG mapping data structure, and the memory sub-system controller can use the EG to identify the other region(s) of the NVMe device as the location for storing the data, and then store the data in the other region(s) of the NVMe device.

Advantages of the present disclosure include improved performance by reducing the processing steps in the memory sub-system controller compared to the FDP by isolating two regions of the memory device and using the association of namespace to filesystem to identify the region. Aspects of the present disclosure give a granular control over the data placement for data in dual-type (i.e., data of a specific type and data not of the specific type) and further improve performance and quality of service of the memory sub-system. According to the present disclosure, instead of using separate memory devices for different types of data generated in a large dataset such as during AI model training, the isolation of the regions in a same memory device allows an improved management over the large dataset.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processors.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

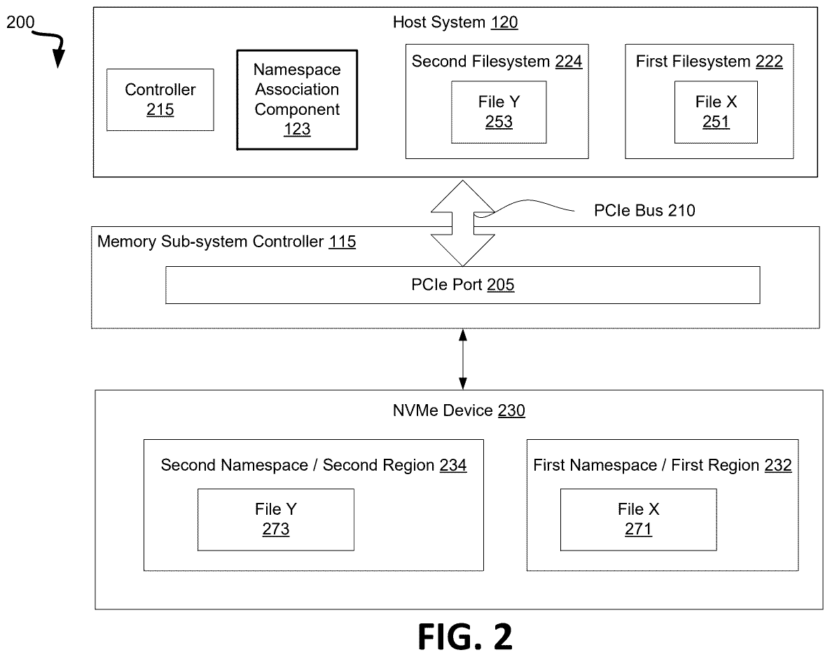

In some embodiments, the host system 120 includes a namespace association component 123 that enables the host system 120 to implement data placement with namespace granularity in the memory sub-system 110. In some embodiments, the namespace association component 123 is part of the CPU, an application, or an operating system. Further details regarding the operations of the namespace association component 123 are described below with reference to FIGS. 2-5.

FIG. 2 illustrates a host system implementing data placement with namespace granularity in a memory sub-system in accordance with some embodiments of the present disclosure. The system 200 can include the host system 120, a NVMe device 230, and a controller 115 that is operatively coupled with the NVMe device 230. In one embodiment, the controller 115 of memory sub-system 110 is connected to host system 120 over a physical host interface, such as PCIe bus 210. The NVMe device 230 is a non-volatile memory device that offers high throughput and low latency, for example, an SSD that connects directly to the PCIe bus 210 for ultra-fast data transfer and low latency. In some implementations, the NVMe device 230 may be the memory device 130.

Specifically, the host system 120 is capable of distinguishing data in different types and associating the data to corresponding filesystems, where each filesystem is associated with a respective namespace of the NVMe device 230. The host system 120 may send the write commands including data associated with a filesystem, where the filesystem is mapped to a specific namespace, and the write commands may include the namespace information. The NVMe device 230 includes logical to process the namespace information to identify the physical locations for writing the data associated with the filesystem. For example, the NVMe device 230 may include a first set of RUs that are allocated to a first namespace and a second set of RUs that are allocated to a second namespace. However, to distinguish from the RU used in the FDP, a first region 232 that includes a set of management units may be used to refer to an isolated location that can be used to store the data of a specific type, and a second region 234 that includes a set of management units may be used to refer to another location that can be used to store the data not of a specific type. In some implementations, the first region 232 is created to include a predetermined number of management units (e.g., blocks) of the NVMe device 230 and is designated for storing data (generated by an application) of a specific type, and the second region 234 is created to include a predetermined number of management units (e.g., blocks) of the NVMe device 230 and is designated for storing data (generated by an application) other than a specific type. In some implementations, creating each of the first and second regions may involve, for each region, storing, in a location (e.g., at the beginning) of the management units, information that identifies a type of data that can be stored in the region.

In some implementations, the host system 120 may configure the NVMe device 230 via a set of NVMe commands (e.g., via NVMe command line interface (CLI)) to have one isolated region and the other region(s) of the NVMe device 230. For example, the host system 120 may, via the NVMe commands, create multiple NVMe namespaces. In some implementations, the host system 120 may create a set of namespaces by allocating physically-separate segments of storage to different namespaces. In some implementations, the logical address space of the NVMe device 230 is divided into namespaces that allow for more efficient management of data. In some implementations, the namespaces are created so that operations performed on the namespaces would have minimum interference over each other. In some implementations, the host system 120 may, via the NVMe commands, configure a set of EGs on the NVMe namespace. In some implementations, the host system 120 may, via the NVMe commands, map each namespace set by the host system 120 to a respective EG of the set of EGs.

In some implementations, the memory sub-system controller 115 may maintain a data structure (“EG mapping data structure”) that maps the namespace to the EG. In some implementations, the memory sub-system controller 115 may select the first set of management units to form a first region and map the first region to the first namespace, and the memory sub-system controller 115 may select the second set of management units to form a second region and map the second region to the second namespace. In some embodiments, the number of namespaces can be preconfigured at manufacturing based on offline testing and media characterization of the memory device. In some embodiments, the number of the set of management units that can be mapped to namespaces can be preconfigured at manufacturing based on offline testing and media characterization of the memory device. After creating one or more namespaces, the memory sub-system controller 115 can assign each namespace to a respective EG. The EG can be used to point to the region that is mapped to the namespace, thus pointing to the set of management units in the region. The EG is unique to the specific namespace, and the specific namespace can only have one EG identifier. In some implementations, the memory sub-system controller 115 can store the assignment of the EG to the namespace (e.g., identified by a namespace identifier) in a data structure. The data structure can also include a mapping of the set of management units to a particular namespace identifier. In some implementations, the data structure include one or more entries, including a namespace identifier, an EG, a set of management units (e.g., identified by physical addresses). The namespace identifier can be used to identify a namespace to which it is assigned. The namespace identifier can be used to identify a specific set of management units to which the namespace is mapped. The set of management units can be used to identify the segment of the memory device to perform the operation. The memory sub-system controller 115 can present the namespace information to the host system 120 such that the host system can use.

In some implementations, the host system 120, through a process (e.g., an application, a virtual machine), may create a specific-type file system (e.g., first filesystem 222) on a first namespace associated with the NVMe device 230 and a general file system (e.g., second filesystem 224) on a second namespace associated with the NVMe device 230. For example, the host system 120 may perform an AI model training through an application, and the application may request to store data generated during the AI model training on the NVMe device 230 and create filesystems to organize such data. The namespace association component 123 can then create a first filesystem 222 on a first namespace (e.g., to store checkpoint data generated by the application) and a second filesystem 224 on a second namespace (e.g., to store all types of data other than checkpoint data, generated by the application) on the NVMe device 230. In some implementations, creating the filesystem on a namespace may involves creating a partition table, formatting the namespace, creating a region (e.g., superblock) for storing metadata of the filesystem and a region (e.g., inode table) for storing metadata of individual files, creating block bitmap to track the status of the blocks (e.g., free or in use). Creating the filesystem on the namespace may involve mapping the namespace to the filesystem. In some implementations, the host system 120 may maintain a data structure (“placement data structure”) to record the mapping of the filesystem to the namespace.

In some implementations, the namespace association component 123 may create a first mount point (e.g., directories) for the filesystem 222 and a second mount point (e.g., directories) for the filesystem 224. In some implementations, the namespace association component 123 may mount the filesystem 222 through the first mount point and mount the filesystem 224 through the second mount point so that a host system can access the file system to write or read data. Mounting a filesystem creates a binding, for the duration of the mount, between a directory that is already in the file system hierarchy, called the mount point, and the entry point into the file system about to be mounted, called the root of the file system. The mount point directory and the root are connected until unmount time. When a filesystem is mounted on a mount point, it overlays the contents of the mount point directory, such that files, symbolic links, and subdirectories within the mount point directory are no longer accessible and are hidden until the filesystem is unmounted. Upon mounting the filesystem, the host systems 120 can have knowledge of the mounted filesystem.

In some implementations, the host system 120, through a process (e.g., an application, a virtual machine), may generate data to be stored in the NVMe device 230. The namespace association component 123 may determine a type of the data, for example, according to metadata of data. In some implementations, the host system 120, through a process (e.g., an application, a virtual machine), may generate metadata that indicate the type of the data when generating the data. For example, the host system 120, may generate metadata indicating the type of data as a checkpoint data type, and the namespace association component 123 may determine a type of data as a checkpoint data type. In one example, the host system 120 may perform an AI model training and generate various data, including checkpoint data. Checkpoint data refers to states of a system, application, or process saved at specific points of time. Checkpoint data may be used to restore the system, application, or process by restarting from the saved point instead of starting over from the beginning. The host system 120 may generate the checkpoint data with metadata that indicates its type as checkpoint data type.

In some implementations, upon determining the type of data as a specific type (e.g., checkpoint data), the namespace association component 123 may associate the data to a first filesystem. Referring to the example illustrated in FIG. 2, the host system 120 may generate the data as file X, and upon determining the type of data of file X as checkpoint data type, the namespace association component 123 may associate the file X to the first filesystem 222.

In some implementations, upon determining the type of data not as a specific type (e.g., not checkpoint data), the namespace association component 123 may associate the data to a second namespace. Referring to the example illustrated in FIG. 2, the host system 120 may generate the data as file Y, and upon determining the type of data not as checkpoint data type, the namespace association component 123 may associated the file Y to the second filesystem 224.

The host system 120, via a process (e.g., an application, a virtual machine), may send a request (e.g., write( )) in system calls to the namespace association component 123, and the namespace association component 123 may translate generic file operations into specific filesystem calls (e.g., EXT4, XFS), manage file metadata, allocate storage blocks, handle block-level operations by breaking file data into chunks suitable for storage on the NVMe device 230, and convert filesystem requests into NVMe command sets (such as NVM commands for write). The namespace association component 123 may communicates directly with the NVMe device 230 over PCIe bus 210.

In some implementations, the namespace association component 123 may send a request to write the data to the NVMe device 230. For example, the namespace association component 123 may send, to the memory sub-system controller 115, a request (e.g., NVM command for write) to write the data of file X or file Y. Because the host system 120 has mapped the namespace to the filesystem when creating the filesystems, the request may include namespace information (e.g., namespace identifier) that specifies a namespace in which the operation to write data would be performed.

In some implementations, the namespace association component 123 may send a request, including the first namespace, to write the first data item of the specific-type file system to the NVMe device 230. For example, the namespace association component 123 may send, to the memory sub-system controller 115, a request (e.g., NVM command for write) to write the first data item of file X, where the request includes the first data item and the first namespace.

The memory sub-system controller 115 may receive the request, with the first namespace information (e.g., namespace identifier), to write the first data item of the specific-type file system to the NVMe device 230. The memory sub-system controller 115 may translate the first namespace information (e.g., namespace identifier) into a EG (e.g., EG 1) according to the EG mapping data structure, and the EG (e.g., EG 1) may be an identifier corresponding to a specific region of the NVMe device 230, and the memory sub-system controller 115 may store the first data item of the specific-type file system in the specific region. That is, the namespace can be understood by the memory sub-system controller 115 to write the data to a specific location of the NVMe device 230. Referring to the example illustrated in FIG. 2, the memory sub-system controller 115 may translate the first namespace information specified in the request into a EG (e.g., EG 1), where the EG (e.g., EG 1) corresponds to first region 232, and thus store the first data item of file X in first region 232. Upon completion of writing the first data item, the memory sub-system controller 115 may send a completion notification to the host system 120 indicating the success of writing the first data item (e.g., file X) in the first region 232.

In some implementations, the namespace association component 123 may send a request, including the second namespace, to write the second data item of the general file system to the NVMe device 230. For example, the namespace association component 123 may send, to the memory sub-system controller 115, a request (e.g., NVM command for write) to write the second data item of file Y, where the request includes the second data item and the second namespace.

The memory sub-system controller 115 may receive the request, with the second namespace information (e.g., namespace identifier), to write the second data item of the general file system to the NVMe device 230. The memory sub-system controller 115 may translate the second namespace information (e.g., namespace identifier) into a EG (e.g., EG 2) according to the EG mapping data structure, and the EG (e.g., EG 2) may be an identifier corresponding to a specific region of the NVMe device 230, and the memory sub-system controller 115 may store the second data item of the general file system in the specific region. Referring to the example illustrated in FIG. 2, the memory sub-system controller 115 may translate the second namespace information specified in the request into a EG (e.g., EG 2), where the EG (e.g., EG 2) corresponds to second region 234, and thus store the second data item of file Y in second region 234. Upon completion of writing the second data item, the memory sub-system controller 115 may send a completion notification to the host system 120 indicating the success of writing the second data item (e.g., file Y) in the second region 234.

The namespace association component 123 can manage the storage and retrieval of data in the NVMe device 230 through the filesystems. The namespace association component 123 can include data structures used to organize the data and can involve separating the data into storage units that can be individually identified and accessed. The namespace association component 123 can be integrated into a kernel, a user space driver, a device driver, an application, other portion of operating system, or a combination thereof. The namespace association component 123 can execute as one or more system processes (e.g., kernel processes), user processes (e.g., application processes), or a combination thereof.

The namespace association component 123 can include multiple layers, including a logical file system (e.g., logical layer), a virtual file system (e.g., virtual layer), a physical file system (e.g., physical layer), or other layers. The logical file system can manage interaction with applications (e.g., through node) and can provide an application program interface (API) that exposes file system operations (e.g., open, close, create, delete, read, write, execute) to other computer programs. The logical layer of file system can manage security and permissions and maintain open file table entries and per-process file descriptors. The logical file system can pass requested operations (e.g., write requests) to one or more other layers for processing. The virtual file system can enable operating system to support multiple concurrent instances of physical file systems, each of which can be referred to as a file system implementation. The physical file system can manage the physical operation of the storage device. The physical file system can handle buffering and manage main memory and can be responsible for the physical placement of storage units in specific locations on the memory device 130. The physical file system can include device mapping logic and can interact with device drivers or with the channel to interact with the memory device 130. One or more of the file system layers can be explicitly separated or can be combined together in order to store file system data.

File system data can be any data associated with file system and can include data received by file system or data generated by file system. File system data can include data of one or more external file system objects, internal file system objects, or a combination thereof. The external file system objects can be file system objects that are externally accessible by a computer program (e.g., applications) using file system API. The external file system objects can include files (e.g., file data and metadata), directories (e.g., folders), links (e.g., symbolic links, hard links), or other objects. The internal file system objects can be file system objects that remain internal to the file system and are inaccessible using file system API. The internal file system objects can include storage tree objects (e.g., extent map, extent tree, block tree), stream objects (e.g., stream identifiers), file group data (e.g., group of similar files), storage units, block groups, extents, or other internal data structures.

Each file system object can be associated with object data and object metadata. The object data can be the content of the object (e.g., file data). For example, the content may be reflective of a state of the application (e.g., including information that represents the values of the variables, the memory layout, the position of the instruction pointer, and other details about the state of the application). The object metadata can be information about the object (e.g., file metadata). The object metadata can indicate attributes of the object such as a storage location (e.g., zone, block group, storage unit), data source (e.g., stream, application, user), data type (e.g., text, image, audio, video), size (e.g., file size, directory size), time (e.g., creation time, modification time, access time), ownership (e.g., user ID, group ID), permissions (e.g., read, write, execute), file system location (e.g., parent directory, absolute path, local path), other attribute, or a combination thereof.

The object data and object metadata (e.g., attributes, tree nodes) can be stored together in the same data structure at the same storage location or can be stored separately in different data structures at different storage locations. For example, file system can store the object metadata in a log data structure and the log data structure can have one or more entries associated with the object data. Each log entry can indicate the attributes and storage locations (e.g., DPA ranges) of the data of the file system object. A directory can be represented as an entry and can contain an entry for itself, its parent (e.g., parent directory), and each of its children (e.g., child directories or files).

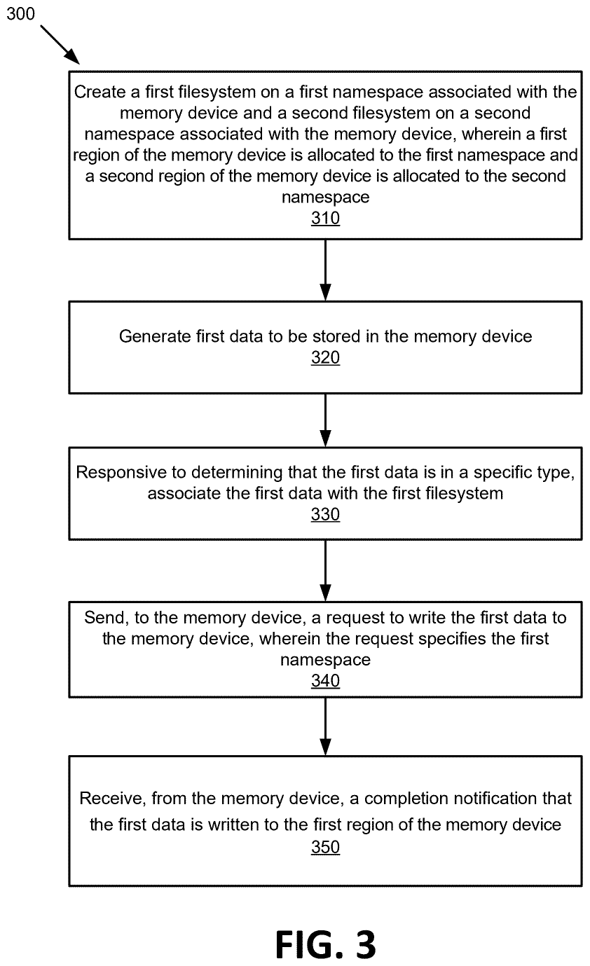

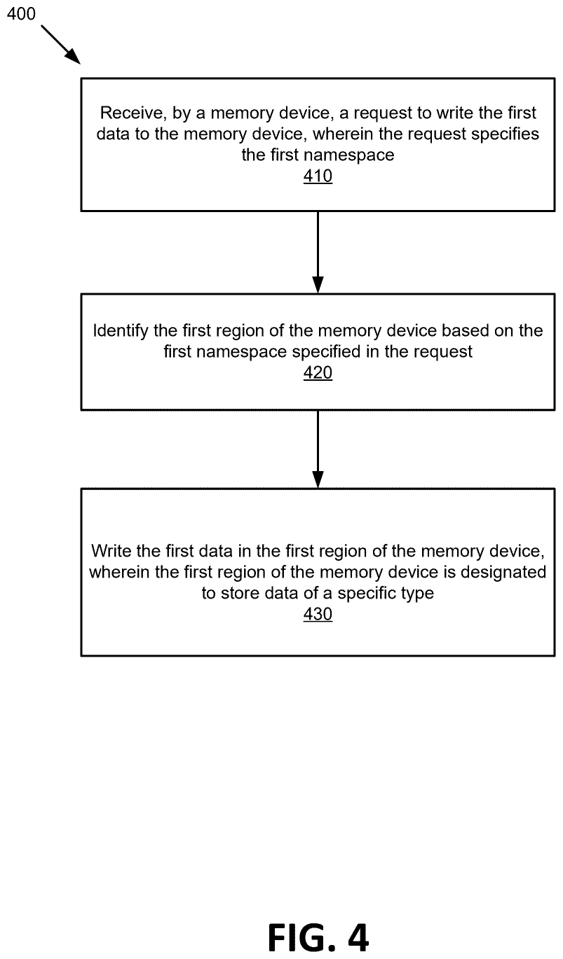

FIGS. 3-4 are flow diagrams of example methods 300-400 to implement data placement with namespace granularity in a memory sub-system in accordance with some embodiments of the present disclosure. The methods 300-400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the namespace association component 123 of FIGS. 1 and 2. In some embodiments, the method 400 is performed by the memory sub-system controller 115 of FIGS. 1 and 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In some implementations, the processing device (e.g., the namespace association component 123) of a host system (e.g., host system 120) can configure a memory device (e.g., NVMe device 230), where a region (e.g., region 232) of the memory device is isolated from the other region(s) (e.g., region 234) of the memory device and designated to store data of a specific type, and where the other region(s) of the memory device is designated to store data not of the specific type. In some implementations, the other region(s) of the memory device can be considered as a second region of the memory device. In some implementations, the memory device is configured via a set of Non-Volatile Memory Express (NVMe) commands. In some implementations, the specific type is a checkpoint data type. In some implementations, the memory device comprises a non-volatile memory device that uses Non-Volatile Memory Express (NVMe) protocol to connect to the host system via a Peripheral Component Interconnect Express (PCIe) interface. In some implementations, the region is configured to store a lowest number of bits per cell supported by the memory device, and the other region(s) is configured to store a higher number of bits per cell than the lowest number of bits per cell in the first region. In some implementations, the region of the memory device is configured as single level cell (SLC) memory, and the other region(s) of the memory device is configured as triple level cell (TLC) memory or quad-level cell (QLC) memory.

Referring to FIG. 3, at operation 310, the processing device (e.g., the namespace association component 123) of a host system (e.g., host system 120) can create a first file system (e.g., first filesystem 222) on a first namespace associated with the memory device (e.g., NVMe device 230) and a second file system (e.g., second filesystem 224) on a second namespace associated with the memory device (e.g., NVMe device 230), wherein a first region (e.g., the first region 232) of the memory device is allocated to the first namespace and a second region (e.g., the second region 234) of the memory device is allocated to the second namespace.

At operation 320, the processing device can generate, via an application running on the host system, the first data item (e.g., data of file X) to be stored in the memory device. At operation 330, responsive to determining that the first data item is of the specific type, the processing device can associate the first data item (e.g., data of file X 251) with the first file system (e.g., first filesystem 222). At operation 340, the processing device can send, to the memory device, a request to write the first data item to the memory device, wherein the request specifies the first namespace. In some implementations, the first namespace specified in the request is used to identify the first region (e.g., the first region 232) of the memory device. In some implementations, the first namespace specified in the request is translatable to an endurance group (EG) , and the EG points to the region of the memory device. At operation 350, the processing device can receive, from the memory device, a completion notification that the first data item (e.g., data of file X 271) of the first file system (e.g., first filesystem 222) is written to the first region (e.g., the first region 232) of the memory device.

In some implementations, the processing device can generate, via the application, second data item (e.g., data of file Y) to be stored in the memory device, responsive to determining that the second data item is not of the specific type, associate the second data item (e.g., file Y 253) with the second filesystem (e.g., second filesystem 224), send, to the memory device, a second request to write the second data item to the memory device, and receive, from the memory device, a second completion notification that the second data item (e.g., file Y 273) of the second file system (e.g., second filesystem 224) is written to the second region (e.g., the second region 234) of the memory device.

Referring to FIG. 4, at operation 410, the processing device (e.g., memory sub-system controller 115) of the memory sub-system can receive, from a host system (e.g., host system 120), a request to write the first data item (e.g., data of file X 251) to the memory device (e.g., NVMe device 230), wherein the request includes the first data item and specifies the first namespace. In some implementations, the first data item is associated with a first file system (e.g., first filesystem 222), and wherein the first file system is created to store data of a specific type. In some implementations, the first data item comprises the checkpoint data.

At operation 420, the processing device can identify the first region (e.g., first region 232) of the memory device based on the first namespace specified in the request. In some implementations, the processing device can translate the first namespace specified in the request a first endurance group (e.g., EG 1), wherein the first endurance group (e.g., EG 1) points to the region (e.g., first region 232) of the memory device.

At operation 430, the processing device can write the first data item (e.g., data of file X 271) in the region (e.g., first region 232) of the memory device, where the region is configured to store a lowest number of bits per cell supported by the memory device. In some implementations, the region of the memory device is isolated from a second region of the memory device and designated to store data of a specific type. In some implementations, the specific type is a checkpoint data type. In some implementations, the second region of the memory device is designated to store data not of the specific type.

In some implementations, the processing device can receive, from a host system (e.g., host system 120), a second request to write the second data item (e.g., data of file Y 253) to the memory device, where the second request includes the second data item and specifies the second namespace. In some implementations, the second data item is associated with a second file system (e.g., second filesystem 224), and wherein the second file system is created to store data not of a specific type. In some implementations, the second data item comprises data other than the checkpoint data. In some implementations, the processing device can identify a second region (e.g., second region 234) of the memory device based on the second namespace specified in the request and write the second data item (e.g., data of file Y 273) in the second region (e.g., second region 234) of the memory device (e.g., NVMe device 230).

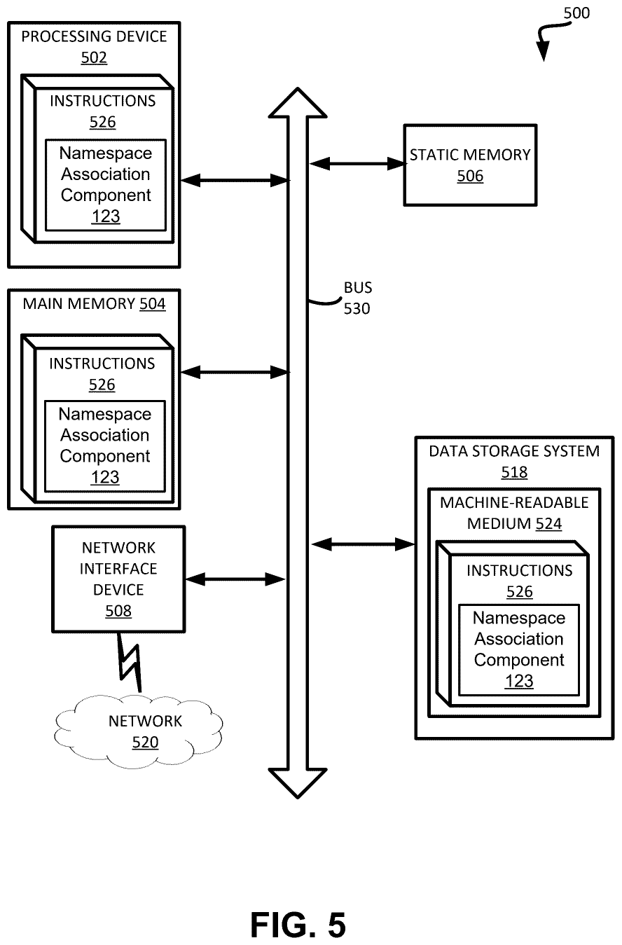

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the namespace association component 123 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a caching component (e.g., the namespace association component 123 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device;
a processing device coupled to the memory device, the processing device to perform operations comprising:
receiving, from a host system, a first write request, wherein the first write request includes a first data item and specifies a first namespace;
identifying, based on the first namespace, a region of the memory device, wherein the region is configured to store a lowest number of bits per cell supported by the memory device; and
writing the first data item to the region of the memory device.

2. The system of claim 1, wherein the region is designated to store data of a specific type.

3. The system of claim 1, wherein the first data item is associated with a first file system, and wherein the first file system is created to store data of a specific type.

4. The system of claim 2, wherein the specific type is a checkpoint data type.

5. The system of claim 1, wherein the operations further comprise:
receiving, from the host system, a second write request, wherein the second write request includes a second data item and a second namespace;
identifying, based on the second namespace, a second region of the memory device, wherein the second region is configured to store a higher number of bits per cell than the lowest number of bits per cell in the region; and
writing the second data item to the second region of the memory device.

6. The system of claim 5, wherein the second region is designated to store data not of a specific type.

7. The system of claim 5, wherein the second data item is associated with a file system, and wherein the second file system is created to store data not of a specific type.

8. The system of claim 1, wherein the memory device comprises a non-volatile memory device that implements Non-Volatile Memory Express (NVMe) protocol to connect to the host system via a Peripheral Component Interconnect Express (PCIe) interface.

9. The system of claim 1, wherein identifying, based on the first namespace, the region of the memory device is performed according to a mapping data structure, wherein the mapping data structure includes a plurality of records, and wherein each record of plurality of records specifies a namespace and a corresponding region of the memory device.

10. The system of claim 1, wherein identifying the region of the memory device further comprises:
translating the first placement identifier to a first endurance group (EG), wherein the first EG points the region of the memory device.

11. A method, comprising:
receiving, from a host system, a first write request, wherein the first write request includes a first data item and specifies a first namespace;
identifying, based on the first namespace, a region of a memory device, wherein the region is configured to store a lowest number of bits per cell supported by the memory device; and
writing the first data item to the region of the memory device.

12. The method of claim 11, wherein the region is designated to store data of a specific type, and wherein the specific type is a checkpoint data type.

13. The method of claim 11, wherein the first data item is associated with a first file system, wherein the first file system is created to store data of a specific type, and wherein the specific type is a checkpoint data type.

14. The method of claim 11, further comprising:
receiving, from the host system, a second write request, wherein the second write request includes a second data item and a second namespace;
identifying, based on the second namespace, a second region of the memory device, wherein the second region is configured to store a higher number of bits per cell than the lowest number of bits per cell in the region; and
writing the second data item to the second region of the memory device.

15. The method of claim 11, wherein the memory device comprises a non-volatile memory device that implements Non-Volatile Memory Express (NVMe) protocol to connect to the host system via a Peripheral Component Interconnect Express (PCIe) interface.

16. The method of claim 11, wherein identifying, based on the first namespace, the region of the memory device is performed according to a mapping data structure, wherein the mapping data structure includes a plurality of records, and wherein each record of plurality of records specifies a namespace and a corresponding region of the memory device.

17. A non-transitory computer readable storage medium comprising instructions, which when executed by a processing device, cause the processing device to perform operations comprising:
receiving, from a host system, a first write request, wherein the first write request includes a first data item and specifies a first namespace;
identifying, based on the first namespace, a region of a memory device, wherein the region is configured to store a lowest number of bits per cell supported by the memory device; and
writing the first data item to the region of the memory device.

18. The non-transitory computer readable storage medium of claim 17, wherein the region is designated to store data of a specific type, and wherein the specific type is a checkpoint data type.

19. The non-transitory computer readable storage medium of claim 17, wherein the first data item is associated with a first file system, wherein the first file system is created to store data of a specific type, and wherein the specific type is a checkpoint data type.

20. The non-transitory computer readable storage medium of claim 17, wherein the operations further comprise:
receiving, from the host system, a second write request, wherein the second write request includes a second data item and a second namespace;
identifying, based on the second namespace, a second region of the memory device, wherein the second region is configured to store a higher number of bits per cell than the lowest number of bits per cell in the region; and
writing the second data item to the second region of the memory device.
